(19) United States
(12) Patent Application Publication
(10) Pub. No.: US 2005/0141074 A1
(43) Pub. Date: Jun. 30, 2005

(54) Electrochromic display device

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/991,318

(22) Filed: Nov. 17, 2004

(30) Foreign Application Priority Data
Dec. 31, 2003 (TW) 92137546

(51) Int. Cl. G02F 1/15

(52) U.S. Cl. 359/265

(57) ABSTRACT

An electrochromic display device (30) generally includes a first sheet (31) and a second sheet (32). A bottom electrode (33), an ion storage layer (34), an electrolyte layer (35), an electrochromic layer (36), and a top electrode (37) are interposed between the first sheet and the second sheet in that order from bottom to top. An external voltage source connects the bottom electrode and the top electrode. The electrochromic layer is a porous nanostructured film, and adheres to the top electrode. Because the electrochromic layer is a porous nanostructured film, it has a very large surface area. Therefore much more electrochromic material adheres to the electrochromic layer, and the electrochromism characteristics of the electrochromic display device are greatly improved.

### BACKGROUND OF THE INVENTION

1. Field of the Invention

The present invention relates to electrochromic display devices, and particularly to an electrochromic display device having an electrochromic layer that is a porous nanostructured film.

2. Description of the Prior Art

Electrochromic materials change color upon application of a voltage. Electrochromic devices are commonly used in windows, automobile rear view mirrors, and flat panel displays.

The change in color of an electrochromic material is usually due to an oxidation/reduction process within the electrochromic material. Most electrochromic devices are responsive in the visible light region. Electrochromic materials active in the visible spectral region include metal oxides such as tungsten trioxide (WO₃), molybdenum trioxide (MoO₃), and nickel oxides. Metal oxides typically range in color from highly colored, such as dark blue, to transparent.

U.S. Pat. No. 4,304,465 issued on Dec. 8, 1981 discloses an electrochromic display device. Referring to FIG. 2, this represents a schematic cross-section of the electrochromic display device. A panel 10 consists of two parallel sheets 12 and 14, which are made of glass or another suitable material. The sheets 12 and 14 are sealed together at peripheries thereof by a sealing glass 16 or another suitable bonding material, thereby hermetically enclosing a space 17 containing electrolyte.

A thin polymer film 18 is deposited on display electrodes 19 by conventional methods, such as the method described in IBM Technical Disclosure Bulletin Vol. 22, No. 4, page 1639, September 1979, which is incorporated herein by reference. The display electrodes 19 are on an inner surface of the sheet 12. Counter electrodes 11 are on an inner surface of the sheet 14. The electrolyte in the space 17 is a conventional electrolyte. Electrical connection between the display electrodes 19 and the counter electrode 11 is effected by means of a conventional edge connection arrangement.

The polymer film 18 needs to be sufficiently insoluble in the electrolyte so that the polymer film 18 remains on the display electrodes 19. Typically, the polymer film 18 is of high molecular weight and insoluble in conventional solvents. If the polymer film 18 is formed by a deposition method, it has good electrical contact with the display electrodes 19. A typical composition of a polymer film formed by the deposition method is described in detail in J.C.S., Chem. Comm., page 635, 1979, which is incorporated herein by reference. Such compositions contain approximately 70% polymer and 30% anion salt. The anion salt may, for example, be BF4.

The thickness of the polymer film 18 is between 0.01 μm and 5 μm, and preferably between 0.05 μm and 1 μm. Typically, there is a tradeoff between color contrast and switching speed. The thinner the polymer film 18, the faster the switching speed. The thicker the polymer film 18, the higher the color contrast.

In the writing step, the polymer film 18 is oxidized to a colored, nontransparent form. In the erasing step, the polymer film 18 is reduced to a neutral transparent form. The writing and erasing steps are effected by varying or switching the potential of the display electrodes 19.

One drawback of the electrochromic display device is that it uses liquid electrolyte. This requires very painstaking packaging when the electrochromic display device is manufactured.

U.S. Pat. No. 5,995,273 issued on Nov. 30, 1999 discloses another kind of electrochromic display device. Referring to FIG. 3, the electrochromic display device 20 includes a first substrate 21, a second substrate 22, a frame 23, a conductive connector 24, a counter electrode 25, an electrolyte layer 26, and an electrochromic layer 27. The electrolyte layer 26 is liquid or solid. If the electrolyte layer 26 is solid, this overcomes the above-described problem of U.S. Pat. No. 4,304,465.

However, because of the characteristics of the material of the electrochromic layer 27, relatively little electrochromic material adheres to the electrochromic layer 27. As a result, upon application of a voltage, the electrochromism of the electrochromic display device 20 is diminished. In addition, the electrochromic display device 20 operates according to only the single electrochromic layer 27. This means that the optical density differences are difficult to adjust, and the color changes are less pronounced. That is, the electrochromism is diminished.

### SUMMARY OF THE INVENTION

It is therefore an objective of the present invention to provide an electrochromic display device having improved electrochromism characteristics.

In order to achieve the above objective, an electrochromic display device in accordance with the present invention generally includes a first sheet and a second sheet. A bottom electrode, an ion storage layer, an electrolyte layer, an electrochromic layer, and a top electrode are interposed between the first sheet and the second sheet in that order from bottom to top. An external voltage source connects the bottom electrode and the top electrode. The electrochromic layer is a porous nanostructured film, and adheres to the top electrode.

Because the electrochromic layer of the electrochromic display device is a porous nanostructured film, it has a very large surface area. Therefore much more electrochromic material adheres to the electrochromic layer, and the electrochromism characteristics of the electrochromic display device are greatly improved.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic, side cross-sectional view of an electrochromic display device of the present invention;

FIG. 2 is a schematic, side cross-sectional view of a conventional electrochromic display device; and

FIG. 3 is a schematic, side cross-sectional view of another conventional electrochromic display device.

### DETAILED DESCRIPTION OF THE INVENTION

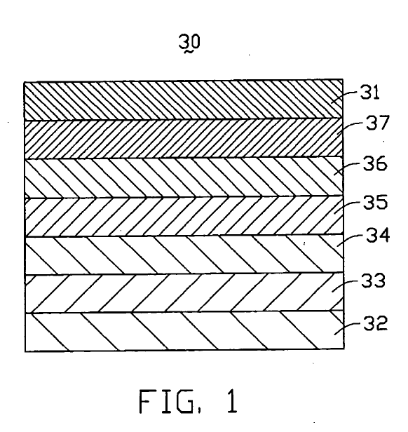

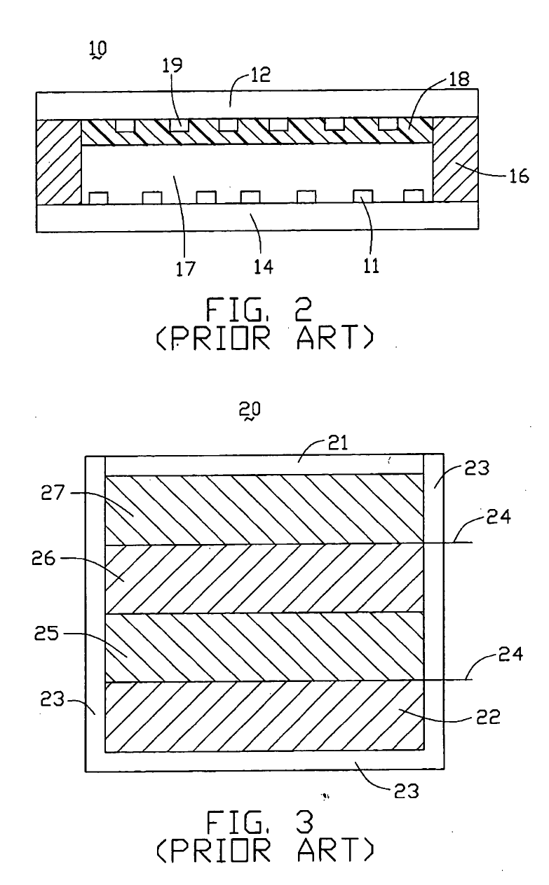

Referring to FIG. 1, an electrochromic display device 30 and an assembly thereof in accordance with a preferred embodiment of the present invention includes a top first sheet 31 and a bottom second sheet 32. The first and second sheets 31, 32 are made of glass or another suitable material. A bottom electrode 33, an ion storage layer 34, an electrolyte layer 35, an electrochromic layer 36, and a top electrode 37 are interposed between the first sheet 31 and the second sheet 32 in that order from bottom to top. The electrochromic display device 30 is driven by an external voltage source (not shown) that connects the bottom electrode 33 and the top electrode 37.

At least one of the sheets 31, 32 is a transparent glass sheet for displaying images. The bottom electrode 33 and the top electrode 37 are both transparent indium tin oxide (ITO) films, and respectively act as a counter electrode and a display electrode of the electrochromic display device 30. The ITO films are formed respectively on the first sheet 31 and the second sheet 32 by sputtering a target containing approximately 20% indium trioxide (In₂O₃) and 80% tin oxide (SnO).

The ion storage layer 34 is made of niobium pentoxide (Nb₂O₅), and is formed on the bottom electrode 33 by electron beam evaporation or ion beam deposition. Niobium pentoxide is an electrochromic material. Thus, the ion storage layer 34 is regarded as a secondary electrochromic layer so that it can adjust optical density differences of the electrochromic display device 30 and provide various color changes.

The electrolyte layer 35 is made of tantalic oxide (Ta₂O₅) doped with hydrogen ions. The electrolyte layer 35 is formed on the electrochromic layer 36 by electron beam evaporation or ion beam deposition, and provides stimulant hydrogen ions for the electrochromic layer 36.

The electrochromic layer 36 is a monolayer or multilayer porous nanostructured film, and adheres to the top electrode 37. The electrochromic layer 36 is made of nickel oxide (NiO). Because the electrochromic layer 36 is a nanostructured film, it has a surface area approximately 1000 times larger than that of a conventional electrochromic layer. Therefore much more electrochromic material adheres to the electrochromic layer 36, so that the electrochromism characteristics are greatly improved.

The electrochromic display device 30 changes color upon application of a voltage. It has been found that a light transmittance of the electrochromic display device 30 in a dark environment is kept within the range from 70˜90%, and a light transmittance of the electrochromic display device 30 in a bright environment is kept below 40%. That is, the electrochromic display device 30 achieves excellent electrochromism.

In summary, because the nanostructured electrochromic layer 36 has a very large surface area, more electrochromic material adheres to the electrochromic layer 36. This improves the electrochromism characteristics of the electrochromic display device 30. In addition, the ion storage layer 34 is made of an electrochromic material; namely, niobium pentoxide. Thus the ion storage layer 34 is regarded as a secondary electrochromic layer of the electrochromic display device 30. That is, the ion storage layer 34 improves the electrochromism characteristics of the electrochromic display device 30.

The present invention may have other alternative embodiments as follows. The electrolyte layer 35 can be made of a polymer electrolyte, a polyelectrolyte, or an inorganic electrolyte. The polymer electrolyte is preferably a polymer doped with lithium hypochlorite (LiClO) or phosphoric acid (H₃PO₄). The polyelectrolyte is a polymer that can provide ions. The inorganic electrolyte is generally a transition metal oxide or an alkali salt; for example, lithium tantalite (LiTaO₃). The electrochromic layer 36 can be made of titanium oxide (TiO₂).

It is to be understood that even though numerous characteristics and advantages of the present invention have been set out in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrochromic display device, comprising:
a first sheet;
a second sheet;
a bottom electrode, an ion storage layer, an electrolyte layer, an electrochromic layer, and a top electrode interposed between the first sheet and the second sheet in that order; and
an external voltage source that connects the bottom electrode and the top electrode;
wherein the electrochromic layer is a porous nanostructured film, and adheres to the top electrode.

2. The electrochromic display device as recited in claim 1, wherein the ion storage layer comprises niobium pentoxide (Nb₂O₅).

3. The electrochromic display device as recited in claim 1, wherein the electrochromic layer comprises nickel oxide (NiO).

4. The electrochromic display device as recited in claim 1, wherein the electrochromic layer comprises titanium oxide (TiO₂).

5. The electrochromic display device as recited in claim 1, wherein the electrochromic layer has a monolayer structure.

6. The electrochromic display device as recited in claim 1, wherein the electrochromic layer has a multilayer structure.

7. The electrochromic display device as recited in claim 1, wherein the electrolyte layer comprises tantalic oxide (Ta₂O₅) doped with hydrogen ions.

8. The electrochromic display device as recited in claim 1, wherein the electrolyte layer comprises a polymer electrolyte.

9. The electrochromic display device as recited in claim 1, wherein the electrolyte layer comprises a polyelectrolyte.

10. The electrochromic display device as recited in claim 1, wherein the electrolyte layer comprises an inorganic electrolyte.

11. The electrochromic display device as recited in claim 10, wherein the electrolyte layer comprises lithium tantalite (LiTaO₃).

12. An electrochromic assembly comprising:
an electrochromic layer with porous nanostructures;
an electrolyte layer electrically contacted with said electrochromic layer;
at least one electrode electrically contacted with said electrochromic layer; and
an external power source electrically connected with said at least one electrode so as to electrically alter an extent of light transmittance of said electrochromic layer via said at least one electrode.

13. The electrochromic assembly as recited in claim 12, further comprising an ion storage layer used as a secondary electrochromic layer to contribute to said extent of light transmittance of said electrochromic layer.

14. The electrochromic assembly as recited in claim 13, wherein said ion storage layer is electrically and exclusively contacted with said electrolyte layer.

15. An electrochromic assembly comprising:
an electrochromic layer;
an electrolyte layer electrically contacted with said electrochromic layer;
a secondary electrochromic layer arranged at a side of said electrolyte layer opposite to said electrochromic layer and electrically contacted with said electrolyte layer rather than said electrochromic layer;
at least one electrode electrically contacted with said electrochromic layer; and
an external power source electrically connected with said at least one electrode so as to electrically alter an extent of light transmittance of said electrochromic layer and secondary electrochromic layer via said at least one electrode.

16. The electrochromic assembly as recited in claim 15, further comprising another electrode electrically contacted with said secondary electrochromic layer and electrically connected with said external power source.

17. The electrochromic assembly as recited in claim 15, wherein said secondary electrochromic layer is an ion storage layer made of niobium pentoxide (Nb₂O₅).

18. The electrochromic assembly as recited in claim 15, wherein said electrochromic layer has a porous nanostructures.
